(19) United States
(12) Patent Application Publication
(10) Pub. No.: US 2003/0202430 A1
(43) Pub. Date: Oct. 30, 2003

(54) Domain wall displacement type magneto-optical recording medium and method of producing same

(76) Inventor: Koichiro Nishikawa, Gunma (JP)

Correspondence Address: FITZPATRICK CELLA HARPER & SCINTO, 30 ROCKEFELLER PLAZA, NEW YORK, NY, 10112, US

(21) Appl. No.: 10/410,351

(22) Filed: Apr. 10, 2003

(30) Foreign Application Priority Data
Apr. 24, 2002 (JP) 122431/2002

(51) Int. Cl. G11B 11/00

(52) U.S. Cl. 369/13.47

(57) ABSTRACT

A domain wall displacement type magneto-optical recording medium is provided that can perform stable domain wall movement and prevent cross-write while adopting the land/groove recording to attain a narrow track pitch.

The magneto-optical recording medium includes a magnetic layer of a stack structure formed of a domain wall displacement type reproducing layer, a switching layer and a record holding layer, wherein both a land and a groove are used as a recording/reproducing track, and wherein a side wall portion located between the land and the groove is irradiated with a light beam to be annealed.

### BACKGROUND OF THE INVENTION

1. Field of the Invention

The present invention relates to a superhigh-density magneto-optical recording medium and, more particularly, to a magnetic domain wall (hereinafter, simply referred to as “domain wall”) displacement type magneto-optical recording medium having annealed portions between information tracks thereof.

2. Related Background Art

There have been known magneto-optical recording mediums as a rewritable high-density recording medium which have a magnetic thin film in which magnetic domains are written by using thermal energy of a semiconductor laser to record information, and from which an information can be read out by using a magneto-optical effect. In recent years, demand has increased for a further improvement in recording density of magneto-optical recording mediums.

The linear recording density of a magneto-optical recording medium depends largely on the wavelength of a laser of a reproducing optical system and on the numerical aperture of the objective lens. However, there is a limit to improvement in each of the reproducing optical system laser wavelength and. the objective lens numerical aperture. Techniques for improving the recording density by devising the recording medium structure or the reading method have therefore been developed.

For example, Japanese Patent Application Laid-Open No. 6-290496 discloses a domain wall displacement detection (DWDD) technique. According to this technique, information is recorded in a record holding layer in a multilayer film structure having a domain wall moving type reproducing layer, a switching layer and the record holding layer magnetically coupled to each other. At the time of information reproduction, domain walls of a recording mark in the domain wall moving layer are moved by using a temperature gradient formed by irradiation with a light beam. The width of the recording mark is thereby increased. The information recorded in the record holding layer is not changed when the domain walls are moved. A change in the plane of polarization of reflected light beam is then detected. This method enables a recording mark smaller than a size corresponding to a diffraction limit to be reproduced, and enables realization of a magneto-optical recording medium remarkably improved in recording density and transfer rate.

In the process of producing this magneto-optical recording medium, in order to ensure that the movement of domain walls of a recording mark in the domain wall moving type reproducing layer can easily be effected by using a temperature gradient formed by irradiation with a light beam, an annealing is carried out in which adjacent grooves sandwiching a recording/reproducing track are irradiated with a high-power laser to effect a high-temperature annealing of the grooves, thereby modifying the recording medium layer of the groove portions. By this annealing, the effect of preventing the domain walls that form a recording mark from forming a closed magnetic domain can be obtained. The action of the domain wall coercive force is thereby reduced to enable movement of domain walls with improved stability, so that an improved reproducing signal can be obtained. However, it is difficult to attain a narrow track pitch since the grooves are subjected to a high-temperature annealing.

Recently, therefore, an increasing number of studies focused on a type of magneto-optical recording medium having groove portions not annealed but made usable as a recording/reproducing track have been made to further improve the recording density. In this type of recording medium, the recording density can be increased in the radial direction. For example, according to Japanese Patent Application Laid-Open No. 11-195252, a large-depth land/groove recording medium is realized by controlling the surface roughness of groove side wall portions of a substrate. In this manner, formation of a narrow track pitch of about 0.5 μm can be achieved. It has experimentally been confirmed that recording/reproducing on a practical level at a linear recording density of 0.11 μm/bit can be performed by using a large-depth (groove depth: about 100 nm) land/groove substrate with a track pitch of 0.6 μm. This density corresponds to a recording density of 10 Gbits/inch².

However, in the case of land/groove recording, grooves of a comparatively large depth of about 100 nm is required for stable movement of domain walls. Therefore, a temperature distribution formed when the land portion is traced and a temperature distribution formed when the groove portion is traced differ largely from each other because of the near-field behavior of the incident light. More specifically, the recording intensity required at the time of tracing of the land portion is larger than that required at the time of tracing of the groove portion. Therefore, there has been a problem that when recording on the land portion is suitably performed, cross-write on the groove portion occurs.

### SUMMARY OF THE INVENTION

It is, therefore, an object of the present invention to provide a magneto-optical recording medium of the DWDD reproducing system using land/groove recording to attain a narrow track pitch, capable of stable domain wall movement and capable of preventing cross-write.

According to the present invention, there is provided a domain wall displacement type magneto-optical recording medium comprising:

a substrate having a land and a groove formed therein;

a domain wall moving layer having a moving domain wall;

a memory layer for holding a recording magnetic domain; and

a switching layer provided between the domain wall moving layer and the memory layer and having a Curie temperature less than Curie temperatures of the domain wall moving layer and the memory layer,

wherein a side wall portion located between the land and the groove is annealed.

The magneto-optical recording medium of the present invention comprises a domain wall moving layer, a switching layer and a memory layer stacked on each other, wherein both a land and a groove can be used as a recording/reproducing track, and wherein a magnetic property of a side wall portion located between the land and the groove is modified by irradiation with a light beam, thereby magnetically separating the land and the groove.

In the present invention, it is preferred that a step difference between the land and the groove is set to 1/32 to ⅛ of the wavelength of a light source used for recording/reproducing, which value is smaller than those adopted in the conventional land/groove recording type magneto-optical recording mediums.

### BRIEF DESCRIPTION OF THE DRAWINGS

FIG. 1 is a cross-sectional view of a magneto-optical recording medium representing an embodiment of the present invention;

FIG. 2 is a plan view of the magneto-optical recording medium of FIG. 1 for illustrating the arrangement of light beams placed thereon;

FIG. 3 is a schematic view showing an annealing/tracking apparatus for the magneto-optical recording medium of FIG. 1;

FIG. 4 is a schematic view showing a grating;

FIG. 5 is a block diagram of a tracking error generation circuit;

FIG. 6 is a graphical representation showing a light absorption distribution when a side wall is irradiated with an annealing light beam focused on a center of the side wall;

FIG. 7 is a graphical representation showing a temperature distribution when a side wall is irradiated with an annealing light beam focused on a center of the side wall;

FIG. 8 is a diagram for explaining a tracking error at the time of transfer to an adjacent side wall;

FIG. 9 is a diagram showing a light absorption distribution when irradiated with an annealing light beam as detracked by about ¼ of the width of a side wall from a center of the side wall to a groove side; and

FIG. 10 is a diagram showing a temperature distribution when irradiated with an annealing light beam as detracked by about ¼ of the width of a side wall from a center of the side wall to a groove side.

### DETAILED DESCRIPTION OF THE PREFERRED EMBODIMENTS

An embodiment of the present invention will be described with reference to the accompanying drawings.

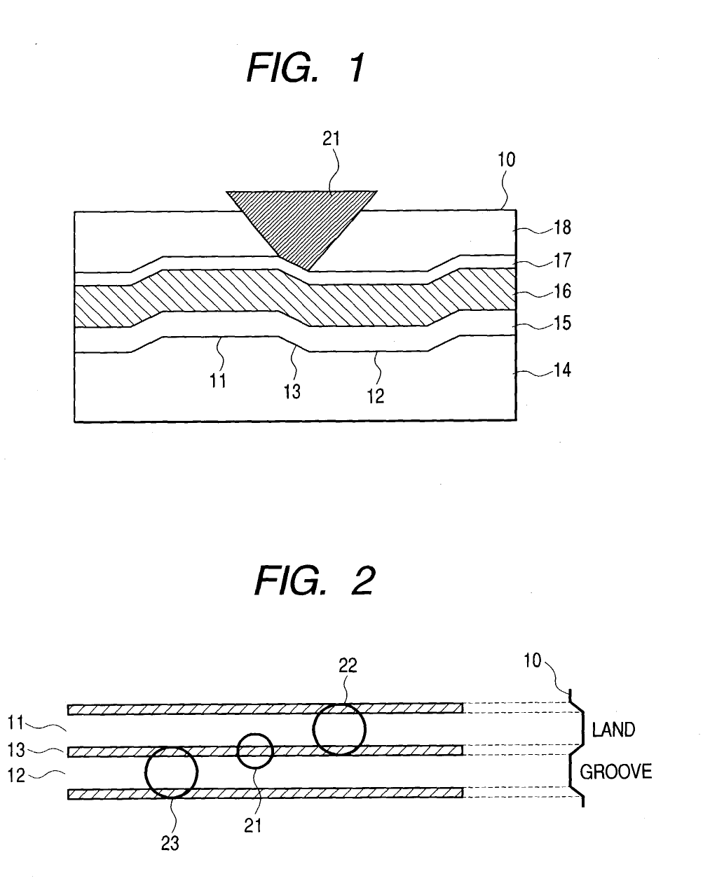

Referring to FIG. 1, a magneto-optical recording medium 10 which represents an embodiment of the present invention has a substrate 14 which has a land 11 and a groove 12, and a lower base layer 15, a magnetic layer 16, an upper base layer 17, and a protective layer 18 stacked on the substrate 14, wherein a side wall portion 13 located between the land 11 and the groove 12 has been annealed with a light beam (main beam) 21 to be modified in the magnetic property thereof such that the land 11 and the groove 12 are magnetically separated from each other. The magnetic layer 16 has a stack structure formed of a domain wall moving type reproducing layer (domain wall moving layer), a switching layer, and a record holding layer (memory layer). The domain wall moving layer has a smaller domain wall coercive force than that of the memory layer and has a function of moving the domain walls of recording magnetic domains transferred from the memory layer. Further, the Curie temperature of the switching layer is lower than those of the domain wall moving layer and he memory layer. The memory layer has a function of holding an information as a recording magnetic domain. The magneto-optical recording medium 10 is adapted for recording and reproducing at a wavelength of 660 nm using an objective lens having NA=0.60. The magneto-optical recording medium 10 is for land/groove recording, and the track pitch is 0.5 μm (the ratio of the widths of the land track and the groove track is about 1:1), the depth of the groove 12 is about 40 nm, and the slope angle of the side wall portion 13 is about 30°. The wavelength of an annealing light beam 21 is 410 nm, and the NA therefor is 0.85. In this embodiment, light beam introduction from a side opposite to the substrate side, suitable for maintaining the quality of a fine spot, is adopted.

FIG. 2 is a plan view of the magneto-optical recording medium 10 showing the arrangement of light beams. The main beam 21 is converged onto the side wall portion 13, and sub beams 22 and 23 are converged onto the land 11 and the groove 12, respectively. The main beam 21 is a high-intensity fine spot for annealing the side wall portion 13 to modify the magnetic property thereof (in-plane magnetized state). The sub beams 22 and 23 are necessary for tracking of an actuator 41 as described below. The intensity ratio of the main beam 21 and the sub beams 22 and 23 is set to about 1:0.1-0.2, so that the annealing does not affect the land 11 and the groove 12. An ordinary push-pull signal cannot be obtained by a spot in the case where the wavelength is 410 nm and the NA of the objective lens is 0.85. Therefore, in order to obtain a push-pull signal, the beam diameters of the sub beams 22 and 23 are increased relative to that of the main beam 21.

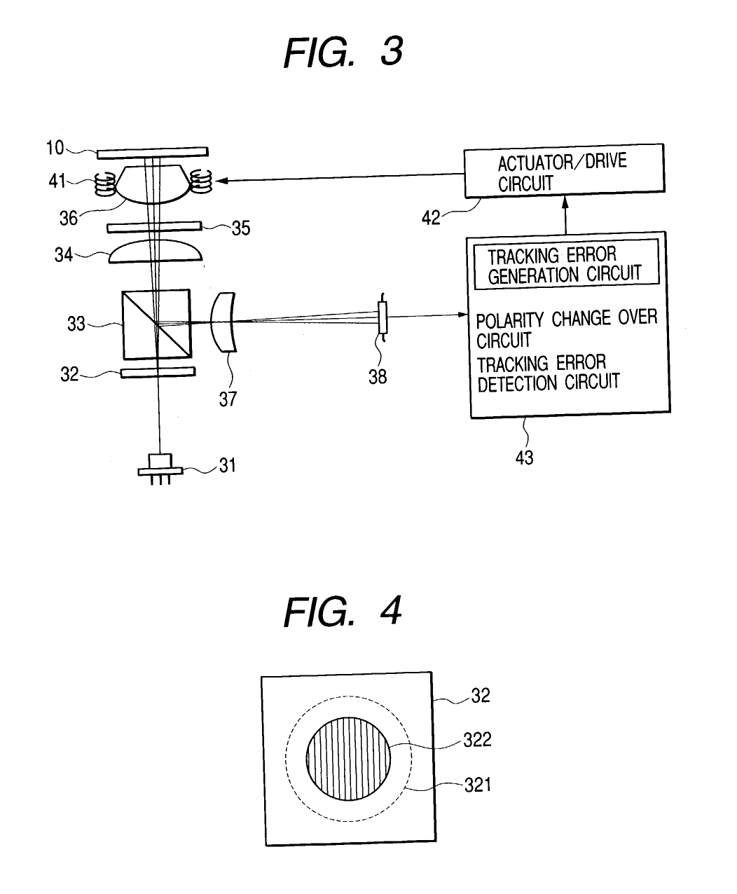

FIG. 3 is a schematic view showing an apparatus for annealing and tracking of the magneto-optical recording medium 10. A beam from a semiconductor laser 31 is separated by a grating 32 into a beam not diffracted and two beams which are ±1 order diffracted light. These beams are passed through a polarization beam splitter (PBS) 33, are made approximately parallel to one another by a collimator 34, are passed through a quarter wavelength plate 35, and are converged as the main beam 21 and the two sub beams 22 and 23 onto the magneto-optical recording medium 10 by an objective lens 36. To obtain a high-intensity fine spot (main beam 21), the wavelength of the semiconductor laser 31 used is 410 nm as mentioned above and the objective lens 36 of NA=0.85 is used. The light source intensity is set to a value optimized such that the intensity of the main beam 21 is within the range of about 5-7 mW when the rotational speed of the magneto-optical recording medium 10 is 2-3 m/s.

The three beams reflected by the magneto-optical recording medium 10 are reflected by the PBS 33 and converge onto a sensor 38 by a sensor lens 37. A tracking error (TE) is detected from output signals obtained by the sensor 38. When the annealing of the side wall portion 13 for one round is completed, because the inclination of the tracking error on the adjacent side wall portion is reversed, the polarity of the tracking error is changed over depending thereon. On the basis of an information from a tracking error generation circuit 43, to anneal the adjacent side wall portion, a tracking servo is applied to an actuator 41 through an actuator drive circuit 42.

FIG. 4 is a schematic view illustrating the grating 32 that forms such a spot as to provide an NA of about 0.55-0.60 of the objective lens using the sub beams 22 and 23. A dotted-line circle 321 represents the beam diameter on the grating 32 corresponding to the entrance pupil of the objective lens 36. The grating is formed in a region 322 smaller than the circle 321, so that the diffracted beam becomes a beam that is thinner than the entrance pupil at the point of the entrance pupil of the objective lens 36 and is converged onto the magneto-optical recording medium 10 as a thinned beam with a small NA. In this case, since the non-diffracted beam has a reduction in intensity at a center portion, the main beam is expected to exhibit the effect of the so-called optical super-resolution. If the groove configuration is such that a push-pull signal can be obtained with the spot formed using the wavelength of 410 nm and the objective lens of NA=0.85, the grating may be provided in a region larger than the dotted-line circuit 321 as in the ordinary practice.

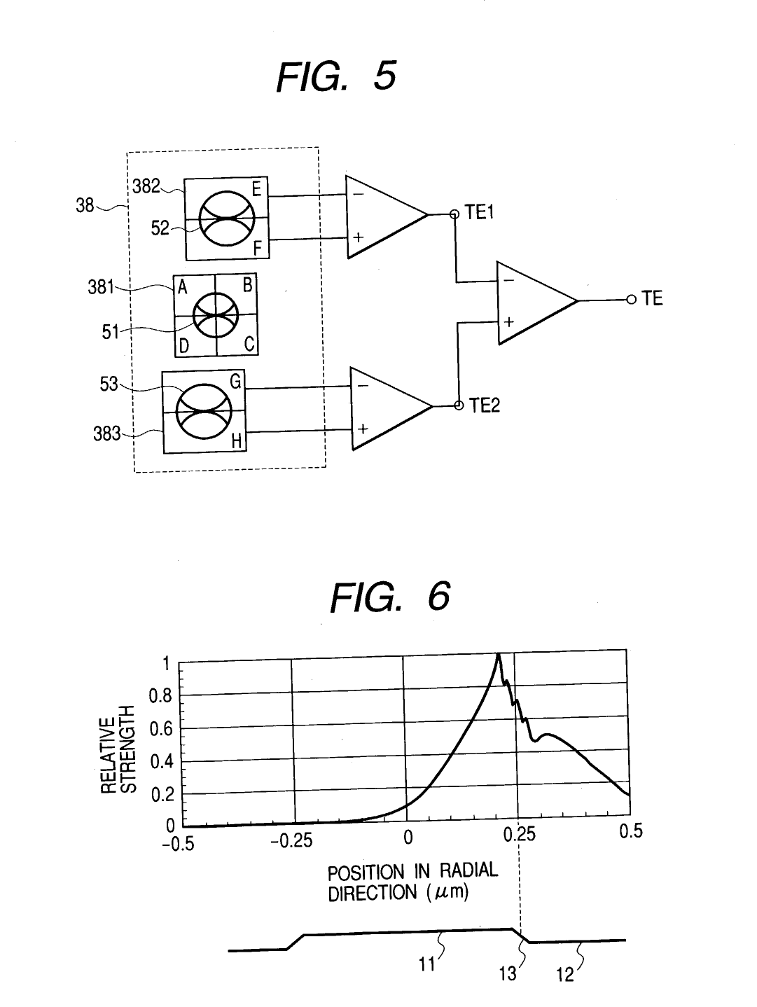

FIG. 5 is a block diagram of the tracking error generation circuit for tracking the side wall portion 13 with the main beam 21. The sensor 38 is constituted of three groups of split sensors 381, 382, and 383 on which spots 51, 52, and 53 are converged in correspondence with the light beams 21, 22, and 23 on the magneto-optical recording medium 10. From the split sensor 381, a focus error signal is obtained on the basis of (A+C)−(B+D). On the other hand, from the split sensors 382 and 383, push-pull tracking error signals are obtained on the basis of TE1=F−E, and TE2=H−G, respectively. Here, the well-known differential push pull method is applied to the subbeams 22 and 23, that is, the corresponding spots 52 and 53. Thus, a tracking error signal in which a DC offset component is suppressed can be obtained thereby. In this manner, application of a stable tracking servo can be performed during annealing of the side wall portion 13. Thus, a tracking servo is applied on the basis of TE, and is further applied with the polarity of TE being changed over at the time of transfer to the adjacent side wall as described above.

Next, with respect to the annealing of the side wall portion 13, there will be described below an analysis of a light spot profile and an amount of light absorbed in a thin film on the basis of vector analysis, and the results of consideration of analysis of temperature distribution on the basis of a thermal diffusion equation using the results of the aforementioned analysis.

FIG. 6 is a graphical representation showing a light absorption distribution (heat generation distribution) in a radial cross section when a side wall is irradiated with an annealing light beam focused on a center of the side wall. In FIG. 6, it is presumed that a center in a horizontal direction of the side wall is located at the position of 0.25 μm in the radial direction and a center in a horizontal direction of the land is located at the center (0 μm) as is seen from the schematic sectional view illustrating the land, side wall and groove portion shown at the bottom of FIG. 6. It can be seen that the light absorption distribution has a peak in the vicinity of the land edge.

It should be noted that the above description to the relationship between the positions in the abscissa and the sectional view shown at the bottom of the figure will also apply to FIGS. 7, 9 and 10.

FIG. 7 is a graphical representation showing a temperature distribution in the radial cross section when the above-described irradiation is performed at a linear velocity of 2.0 m/s. In this embodiment, about 0.8 to 0.9 of the peak temperature (° C.) is defined as a threshold value of the annealing temperature. It can be seen that with respect to the positions corresponding to the relative intensity of 0.8-0.9 (the dotted line indicating the positions of 0.85), the temperature distribution is asymmetric about the center of the side wall to reflect the light absorption distribution shown in FIG. 6. Therefore, when the center of the side wall is irradiated with the annealing light beam, the widths of non-annealed regions, i.e., the recording/reproducing track widths, in the land and the groove will differ from each other. Accordingly, a minute amount of detrack is necessary to be taken into consideration.

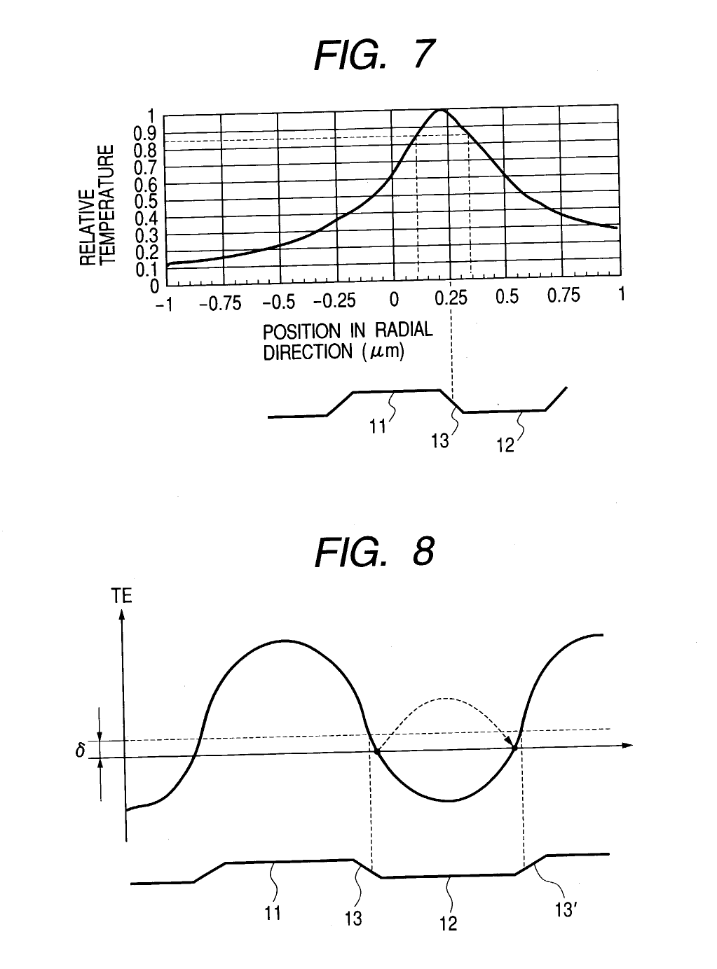

FIG. 8 shows a relationship between the positions of the land/groove and the above-mentioned TE. At the time of transfer from the side wall portion 13 to a side wall portion 13′, the polarity is changed over with an offset 6 for detracking remaining unchanged. In this manner, the detracking to the groove side or the land side (the groove side in FIG. 8) can always be maintained.

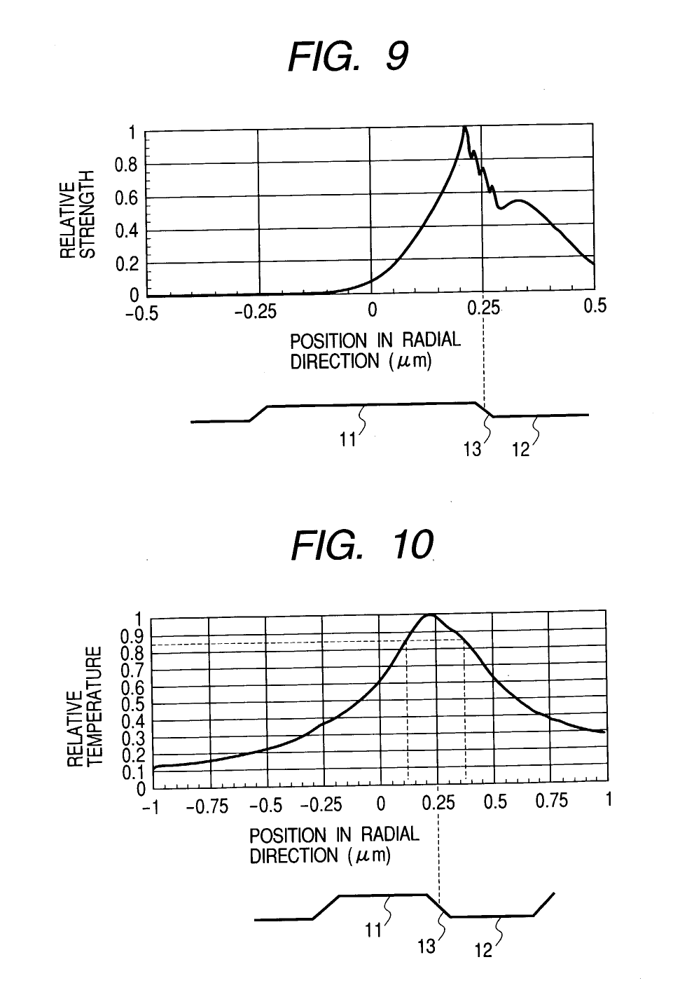

FIG. 9 shows a light absorption distribution (heat generation distribution) in the radial cross section when the side wall is irradiated with an annealing light with the annealing light spot being detracked from the center of the side wall to the groove side by about ¼ of the width of the side wall. Similarly, FIG. 10 shows a temperature distribution in the radial direction when the side wall is irradiated with an annealing light with the annealing light spot being detracked from the center of the side wall to the groove side by about ¼ of the width of the side wall. It can be seen that the light absorption distribution also has a peak in the vicinity of the land edge. However, the amount of absorption of light (generated heat) in the vicinity of the groove edge on the light irradiation point side is larger than that in the case where detracking is not performed. As a result, the temperature distribution becomes more symmetry about the center of the side wall as can be seen from the positions at which the relative intensity is 0.8-0.9 (the dotted line indicating the positions of 0.85).

Description will be made of examination of a land/groove structure capable of suitable side wall annealing. From the comparison between the temperature distribution shown in FIG. 7 and the temperature distribution shown in FIG. 10, it can be seen that the distribution shown in FIG. 10 has a higher symmetry but has a wider temperature peak width. This result shows that it is comparatively difficult to maintain a small annealing range in the case of effecting detracking as shown in FIG. 10. The difference between the temperature distribution shown in FIG. 7 and the temperature distribution shown in FIG. 10 results from the light absorption distributions shown in FIGS. 6 and 9. Analysis and examination were made by changing the conditions to result in the following findings. If the step difference (or difference in level) between the land and the groove is increased, the difference between the light absorption peak in the vicinity of the land edge and the second light absorption peak in the vicinity of the groove edge becomes greater, so that the amount of detrack for obtaining a good symmetry is also increased. As a result, the temperature peak width is increased and it becomes more difficult to maintain the annealing width at a small value. The same can also be said with respect to a case where the inclination of the side wall is increased. From analysis of light absorption obtained by employing a detracked spot and temperature distributions resulting therefrom, it was found that the annealing width falls approximately within a range of from the side wall width to about three times the side wall width if the step difference is not more than about 80 nm and the inclination of the side wall is not more than about 60°. Incidentally, the value 80 nm is about ⅛ of the wavelength of a light source used for recording/reproducing. Further, under the above-described conditions, the amount of detrack is about ½ or less of the side wall width. While the upper limit of the step difference is defined as about 80 nm, the lower limit of the step difference is defined as about 20 nm because it is difficult to obtain the push-pull signal if the step difference is excessively small. Further, the lower limit of the inclination of the side wall is suitably about 20° because the widths of the land/groove become disadvantageously small if the inclination is excessively small.

In this embodiment, annealing was performed while effecting detracting by about ¼ of the width of the side wall portion 13, set as a standard. A magnetic-property-modified region mainly formed of an in-plane magnetized film was thereby formed with the side wall portion 13 being the center, and it was found the width of this region actually measured was larger than the side wall width and smaller than twice the side wall width.

According to the present invention, as described above, recording at a high density in the radial direction can be achieved by using land/groove recording, and stable domain wall displacement reproduction can be performed since the land and the groove are magnetically separated by irradiating the side wall portion between the land and the groove with a light beam to modify the magnetic property thereof. Also, the influence of cross-write or the like can be reduced since the step difference between the land and the groove can be reduced.

What is claimed is:

1. A domain wall displacement type magneto-optical recording medium comprising:
a substrate having a land and a groove formed therein;
a domain wall moving layer having a moving domain wall;
a memory layer for holding a recording magnetic domain; and
a switching layer provided between the domain wall moving layer and the memory layer and having a Curie temperature less than Curie temperatures of the domain wall moving layer and the memory layer,
wherein a side wall portion located between the land and the groove is annealed.

2. The recording medium according to claim 1, wherein the direction of magnetization of the side wall portion is an in-plane direction.

3. The recording medium according to claim 1, wherein the step difference between the land and the groove is 1/32 to ⅛ of a wavelength of a light source used for recording/reproducing.

4. The recording medium according to claim 1, wherein the inclination of the side wall portion is 20° to 60°.

5. A method of producing a domain wall displacement type magneto-optical recording medium, comprising:
the step of successively forming at least a domain wall moving layer, a switching layer and a memory layer on a substrate having a land and a groove formed therein; and
the step of irradiating a side wall portion located between the land and the groove with a light beam to anneal a portion between the land and the groove.
